(19) United States
(12) Patent Application Publication
(10) Pub. No.: US 2022/0376484 A1
(43) Pub. Date: Nov. 24, 2022

(54) CUSHION SHEET AND WIRE HARNESS

(71) Applicant: SUMITOMO WIRING SYSTEMS, LTD., Mie (JP)

(72) Inventor: Tomohiro MATSUMOTO, Mie (JP)

(21) Appl. No.: 17/764,882

(22) PCT Filed: Aug. 28, 2020
(86) PCT No.: PCT/JP2020/032688

§ 371 Date: Mar. 29, 2022

(30) Foreign Application Priority Data
Oct. 9, 2019 (JP) 2019-185880

(51) Int. Cl. H02G 3/32; H01B 7/00; B60R 16/02; F16B 2/08

(52) U.S. Cl. CPC H02G 3/32; H01B 7/0045; B60R 16/0215; F16B 2/08

(57) ABSTRACT

The present disclosure provides a wire harness in which the occurrence of abnormal sound is suppressed. This wire harness (10) comprises: a cable (11); a plurality of band clips (12) which are attached to the cable (11) and are for wiring the cable (11) with respect to an external component; and a cushion sheet (13) which is more flexible than the band clips (12) and covers the individual band clips (12). The cushion sheet (13) comprises: an insertion hole (45) provided on one longitudinal end side; and an insertion section (46) provided to the other longitudinal end side. The insertion section (46) has: a base end section (47) corresponding to the width of the insertion hole (45); and an intermediate section (49) that is positioned closer to the other longitudinal end side than the base end section (47) and has a greater width than the base end section (47).

### TECHNICAL FIELD

The present disclosure relates to a cushion sheet and a wire harness.

### BACKGROUND

Conventionally, in order to mount an electric wire of a wire harness to a vehicle panel, a band clip having a band portion and a clip portion may be used. By wrapping the band portion of the band clip around the electric wire and mounting the clip portion of the band clip to a mounting hole of the vehicle panel, the wire harness is mounted on the vehicle panel and movement of the electric wire wrapped with the band clip is restricted (see, for example, Patent Document 1).

### PRIOR ART DOCUMENT

### Patent Document

Patent Document 1: JP 2001-298836 A

### SUMMARY OF THE INVENTION

### Problems to be Solved

In the above-mentioned wire harness, the position of the mounting hole of the vehicle panel may differ depending on, for example, the vehicle type. In such a case, in order to improve versatility of the wire harness, it is conceivable to mount a plurality of band clips on the wire harness in advance so as to correspond to mounting holes of various vehicle panels. As a result, a clip portion of the band clip that is not mounted to a mounting hole may interfere with the vehicle panel, and noise may be generated.

An object of the present disclosure is to provide a cushion sheet and a wire harness that can suppress the generation of noise.

### Means to Solve the Problem

A cushion sheet of the present disclosure is a cushion sheet that is softer than a harness component and covers the harness component, the cushion sheet including: an insertion hole provided on one end side in a length direction of the cushion sheet; and an insertion portion provided on an other end side in the length direction, wherein the insertion portion includes a narrow portion corresponding to a width of the insertion hole, and a wide portion that is located closer to the other end side in the length direction than the narrow portion is and that wider than the narrow portion.

A wire harness of the present disclosure includes: an electric wire; a plurality of harness components that are attached to the electric wire and are configured to mount the electric wire to an external component; and a plurality of cushion sheets that are softer than the harness components and individually cover the harness components, wherein each of the cushion sheets includes an insertion hole provided on one end side in a length direction of the cushion sheet and an insertion portion provided on an other end side in the length direction, and the insertion portion includes a narrow portion corresponding to a width of the insertion hole, and a wide portion that is located closer to the other end side in the length direction than the narrow portion is and that is wider than the narrow portion.

A wire harness of the present disclosure includes: an electric wire; a plurality of harness components that are attached to the electric wire and are configured to mount the electric wire to an external component; and a plurality of cushion sheets that are softer than the harness components and individually cover all the harness components, wherein the cushion sheet includes an insertion hole provided on one end side in a length direction of the cushion sheet and an insertion portion provided on an other end side in the length direction, and the insertion portion includes a narrow portion corresponding to a width of the insertion hole, and a wide portion that is located closer to the other end side in the length direction than the narrow portion is and that is wider than the narrow portion.

### Effect of the Invention

According to a cushion sheet and a wire harness of the present disclosure, the generation of noise can be suppressed.

### BRIEF DESCRIPTION OF THE DRAWINGS

FIG. 1 is a schematic configuration diagram of a wire harness in an embodiment.

FIG. 2 is a plan view of a cushion sheet in the embodiment.

FIG. 3 is a perspective view for describing a method of attaching the cushion sheet in the embodiment.

FIG. 4 is a perspective view for describing a method of attaching the cushion sheet in the embodiment.

FIG. 5 is a perspective view for describing a method of attaching the cushion sheet in the embodiment.

FIG. 6 is a schematic configuration diagram of the wire harness and a vehicle panel in the embodiment.

FIG. 7 is a schematic configuration diagram of the wire harness and the vehicle panel in the embodiment.

### DETAILED DESCRIPTION TO EXECUTE THE INVENTION

### Description of Embodiments of Present Disclosure

First, embodiments of the present disclosure will be listed and described.

[1] A cushion sheet of the present disclosure is a cushion sheet that is softer than a harness component and covers the harness component, the cushion sheet including: an insertion hole provided on one end side in a length direction of the cushion sheet; and an insertion portion provided on an other end side in the length direction, wherein the insertion portion includes a narrow portion corresponding to a width of the insertion hole, and a wide portion that is located closer to the other end side in the length direction than the narrow portion is and that wider than the narrow portion.

According to this configuration, by inserting the insertion portion of the cushion sheet into the insertion hole, an end surface on the one end side in the length direction of the cushion sheet is locked by a periphery of the insertion hole in the insertion portion, and thus the harness component can be covered without using an adhesive. Therefore, it is possible to prevent the harness component from directly coming into contact with an external component to which the harness is mounted after the harness is mounted, and to suppress the generation of noise. Further, since the insertion hole and the insertion portion provided in the cushion sheet are engaged with each other, adhesion, welding, and the like are not required.

[2] It is preferred that the cushion sheet further includes a main body between the insertion hole and the insertion portion, and the main body has a positioning hole for positioning relative to the harness component.

According to this configuration, due to including the positioning hole in the main body, a part of the harness component can be inserted into the positioning hole, and thus relative misalignment between the harness component and the cushion sheet can be suppressed.

[3] The main body preferably has a pair of slits at positions on opposite sides of the positioning hole, the slits being configured to engage with each other and covering a part of the harness component in a region between the slits.

According to this configuration, the pair of slits can be engaged with each other, and thus adhesion, welding, and the like are not required.

[4] The pair of slits preferably includes: a first slit extending from a first end surface in a width direction of the cushion sheet toward a second end surface in the width direction; and a second slit extending from the second end surface in the width direction toward the first end surface in the width direction.

According to this configuration, since the first slit and the second slit extend in opposite directions in the width direction, when the cushion sheet is wrapped around the harness component so as to cover the harness component, an open end of the first slit and an open end of the second slit face each other, and thus the slits are easily engaged with each other.

[5] It is preferred that the harness component is a band clip configured to be attached to an electric wire, and the main body includes: a first covering portion that is provided between the first slit and the second slit and is configured to cover a band portion of the band clip; and a second covering portion configured to cover a clip portion of the band clip and the first covering portion.

According to this configuration, the band portion can be covered by the first covering portion, and the clip portion and the first covering portion can be covered by the second covering portion, and the entire band clip can be covered. Thus, it is possible to prevent the band clip, which is the harness component, from directly coming into contact with the external component to which the harness is mounted after the harness is mounted, and to suppress the generation of noise.

[6] In the insertion portion, a tip portion located closer to the other end side in the length direction than the wide portion is has a widthwise length that is preferably shorter than a widthwise length of the insertion hole.

According to this configuration, since the widthwise length of the tip portion of the insertion portion is shorter than the widthwise length of the insertion hole, the insertion portion can be easily inserted into the insertion hole.

[7] Further, a wire harness of the present disclosure includes: an electric wire; a plurality of harness components that are attached to the electric wire and are configured to mount the electric wire to an external component; and a plurality of cushion sheets that are softer than the harness components and individually cover the harness components, wherein each of the cushion sheets includes an insertion hole provided on one end side in a length direction of the cushion sheet and an insertion portion provided on an other end side in the length direction, and the insertion portion includes a narrow portion corresponding to a width of the insertion hole, and a wide portion that is located closer to the other end side in the length direction than the narrow portion is and that is wider than the narrow portion.

According to this configuration, since the harness component can be covered by inserting the insertion portion of the cushion sheet into the insertion hole, it is possible to provide a wire harness that can prevent the harness component from directly coming into contact with the external component to which the harness is mounted after the harness is mounted, and can suppress the generation of noise. Further, the insertion hole and the insertion portion provided in the cushion sheet are engaged with each other, and thus adhesion, welding, and the like are not required.

[8] Further, a wire harness of the present disclosure includes: an electric wire; a plurality of harness components that are attached to the electric wire and are configured to mount the electric wire to an external component; and a plurality of cushion sheets that are softer than the harness components and individually cover all the harness components, wherein the cushion sheet includes an insertion hole provided on one end side in a length direction of the cushion sheet and an insertion portion provided on an other end side in the length direction, and the insertion portion includes a narrow portion corresponding to a width of the insertion hole, and a wide portion that is located closer to the other end side in the length direction than the narrow portion is and that is wider than the narrow portion.

According to this configuration, since the harness component can be covered by inserting the insertion portion of the cushion sheet into the insertion hole, it is possible to provide the wire harness that can prevent the harness component from directly coming into contact with the external component to which the harness is mounted after the harness is mounted, and can suppress the generation of noise. Further, the insertion hole and the insertion portion provided the cushion sheet are engaged with each other, and thus adhesion, welding, and the like are not required.

[9] The harness component is preferably a band clip configured to be attached to the electric wire.

According to this configuration, by covering the band clip with the cushion sheet, it is possible to prevent the band clip from directly coming into contact with the external component to which the harness is mounted after the harness is mounted, and to suppress the generation of noise.

### Details of Embodiments of Present Disclosure

A specific example of a wire harness that includes a band clip of the present disclosure will be described below with reference to the drawings. In each figure, for convenience in the description, portions of the configuration may be exaggerated or simplified. In addition, the dimensional ratios of portions may differ from figure to figure. The term “parallel” in the present specification includes not only the case of being strictly parallel but also the case of being substantially parallel within a range in which operations and effects of the present embodiment are obtained. It should be noted that the present invention is not limited to these examples, but rather is indicated by the claims, and is intended to include all modifications within a meaning and scope equivalent to the claims.

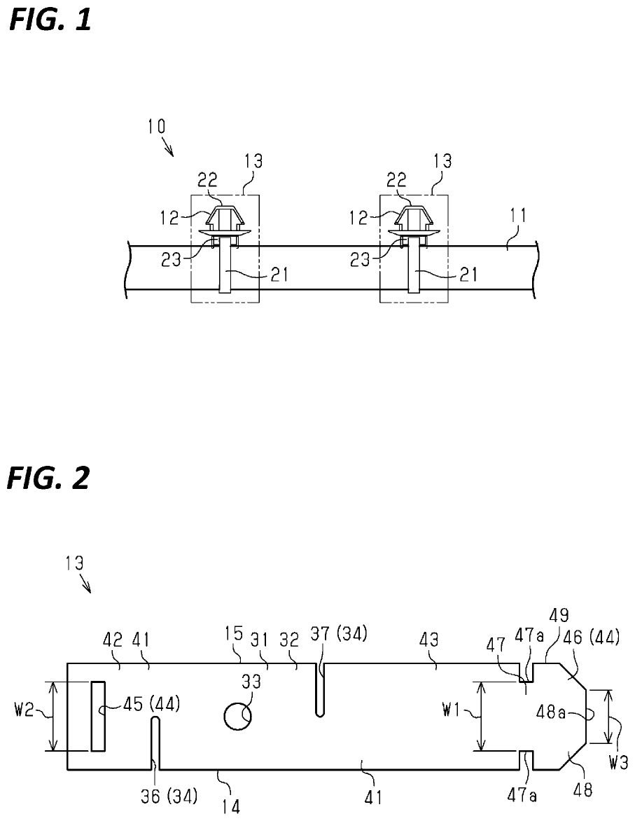

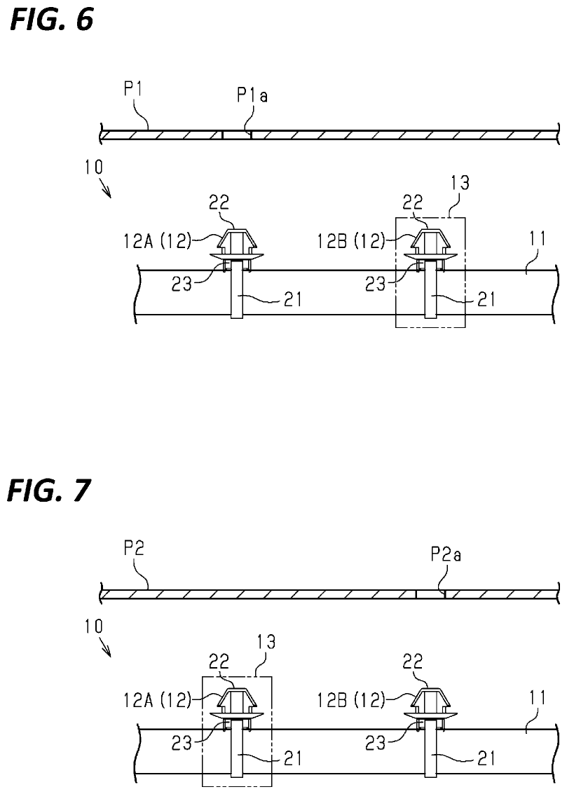

As illustrated in FIG. 1, a wire harness 10 includes an electric wire 11, band clips 12 that are wrapped around the electric wire 11 and are for mounting the electric wire 11 to a vehicle panel (see FIGS. 6 and 7), which is the external component to which the wire harness 10 is to be mounted, and cushion sheets 13 that cover the band clips 12. The electric wire 11 may be a single electric wire or a bundle of electric wires. Note that the vehicle panel is an example of the external component to which the wire harness 10 is mounted, and the band clips 12 may be configured to fix the wire harness 10 to an external component other than the vehicle panel.

In the wire harness 10 of the present embodiment, a plurality of band clips 12 are wrapped around the electric wire 11. All of the band clips 12 are individually covered by a corresponding cushion sheet 13.

Configuration of Band Clip

As illustrated in FIG. 1, the plurality of band clips 12 are provided on the electric wire 11 at positions separated from each other in the lengthwise direction of the electric wire 11. Although two band clips 12 are illustrated in FIG. 1, the number of band clips is not limited to two, and three or more may be provided.

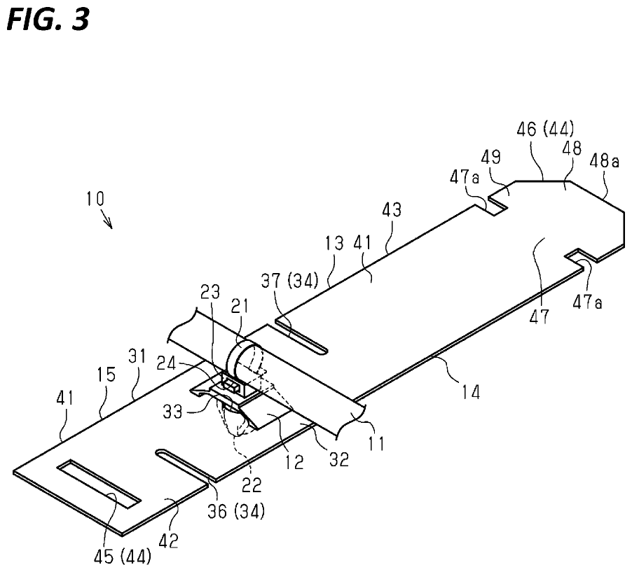

As illustrated in FIGS. 1 and 3, the band clip 12 includes a band portion 21, a clip portion 22, and a lock portion 23. The band clip 12 is made of, for example, a synthetic resin.

The band portion 21 is configured to form a band shape (strip shape) that is elongated in one direction.

As illustrated in FIG. 3, the lock portion 23 has an insertion port 24 into which the band portion 21 can be inserted. A locking claw (not illustrated) is provided on an inner surface of the insertion port 24. On an outer peripheral surface of a tip portion of the band portion 21, a plurality of locking grooves (not illustrated) extending in the width direction of the band portion 21 are formed at predetermined intervals in the length direction of the band portion 21. In the band clip 12, the band portion 21 is locked to the lock portion 23 by engaging the locking claw of the lock portion 23 with one of the locking grooves formed in the band portion 21. In the band clip 12, the tightness of the band portion 21 around the electric wire 11 can be adjusted by changing the extent to which the band portion 21 is inserted into the lock portion 23.

The clip portion 22 is formed integrally with, for example, the band portion 21 and the lock portion 23. The clip portion 22 extends from the lock portion 23. The clip portion 22 is mounted to a vehicle panel P1 or P2 illustrated in FIGS. 6 and 7.

The sizes, shapes, and the like of the clip portions 22 of the band clips 12 of the present embodiment may be the same as each other or different. Further, the widths, thicknesses, and the like of the band portions 21 of the band clips 12 may be the same as each other, or may be different for each band clip 12.

Configuration of Cushion Sheet

The cushion sheet 13 covers the band clip 12 wrapped around the electric wire 11 of the wire harness 10.

As illustrated in FIGS. 2 and 3, the cushion sheet 13 is configured to form a sheet that is elongated in one direction.

The cushion sheet 13 may, for example, be obtained by foam molding a synthetic resin such as polyurethane, or by foam molding synthetic rubber such as EPDM. Further, the cushion sheet 13 may be any foam having an open cell structure, a closed cell structure, or a semi-open cell structure. For example, by employing foam having an open cell structure, the cushion sheet 13 can be provided with excellent sound absorption. Further, by employing foam having a closed cell structure, the cushion sheet 13 can be provided with excellent cushioning properties. Since the cushion sheet 13 is softer than the vehicle panel and the band clip 12, it is possible to suppress the generation of noise as compared with a case where the cushion sheet 13 is omitted, regardless of whether an open cell structure, a closed cell structure, or a semi-open cell structure is used.

As illustrated in FIGS. 2 to 5, the cushion sheet 13 has a first covering portion 31 and a second covering portion 41. The first covering portion 31 covers the band portion 21 of the band clip 12. The second covering portion 41 covers the clip portion 22 of the band clip 12 and the first covering portion 31. Note that the main body of the cushion sheet includes the first covering portion 31 and the second covering portion 41 of the present embodiment.

The first covering portion 31 has a first sheet portion 32, a clip insertion hole 33, and a first engaging portion 34.

The first sheet portion 32 is a sheet extending in the lengthwise direction of the cushion sheet 13.

The clip insertion hole 33 is provided substantially at the center of the first sheet portion 32. The clip insertion hole 33 penetrates in the thickness direction of the cushion sheet 13. The clip insertion hole 33 is a through-hole into which the clip portion 22 of the band clip 12 is inserted. The clip insertion hole 33 of the present embodiment is a through-hole having a substantially perfect circular shape. Note that the clip insertion hole 33 is not limited to having a perfect circular shape, and may have an elliptical shape or a polygonal shape.

The first engaging portion 34 is provided at both ends of the first sheet portion 32. The first engaging portions 34 include a pair of slits 36 and 37. The pair of slits 36 and 37 are a first slit 36 provided on one side of the clip insertion hole 33 in the lengthwise direction of the cushion sheet 13 and the second slit 37 provided on the other side of the clip insertion hole 33 in the lengthwise direction of the cushion sheet 13.

The first slit 36 is a slit that extends from one end surface 14 in the width direction of the cushion sheet 13 toward the center in the width direction. The second slit 37 is a slit that extends from the other end surface 15 in the width direction of the cushion sheet 13 toward the center in the width direction. In the present embodiment, the first slit 36 and the second slit 37 extend parallel to the width direction of the cushion sheet 13. Further, both the first slit 36 and the second slit 37 penetrate in the thickness direction of the cushion sheet 13.

The distance from the first slit 36 to the clip insertion hole 33 is substantially equal to the distance between the second slit 37 and the clip insertion hole 33. For example, the clip insertion hole 33 is provided at the middle point between the first slit 36 and the second slit 37. For example, the first slit 36 and the second slit 37 are provided at point symmetrical positions about a center point of the clip insertion hole 33. The distance from the clip insertion hole 33 to each of the slits 36 and 37 can be appropriately changed according to the diameter of the electric wire 11, and the like.

As illustrated in FIGS. 2 and 3, the second covering portion 41 has a pair of second sheet portions 42 and 43 and a second engaging portion 44.

The second sheet portions 42 and 43 are a second sheet portion 42 located on the first slit 36 side in the lengthwise direction of the cushion sheet 13 and a second sheet portion 43 located on the second slit 37 side in the lengthwise direction of the cushion sheet 13.

The second sheet portion 42 is a sheet that extends in the lengthwise direction of the cushion sheet 13 from an end portion on the first slit 36 side of the first sheet portion 32.

The second sheet portion 43 is a sheet that extends in the lengthwise direction of the cushion sheet 13 from an end portion on the second slit 37 side of the first sheet portion 32.

As illustrated in FIGS. 2 and 3, the second engaging portion 44 has an insertion hole 45 provided in the second sheet portion 42 and an insertion portion 46 provided in the second sheet portion 43.

The insertion hole 45 is a through-hole that penetrates in the thickness direction of the cushion sheet 13. The insertion hole 45 can be, for example, a through-hole having a rectangular opening.

The insertion portion 46 includes a base end portion 47 that is narrower than the second sheet portion 43, a tip portion 48 that is tapered toward a tip side of the insertion portion 46, and an intermediate portion 49 between the base end portion 47 and the tip portion 48.

The base end portion 47 has two slits 47a that extend from the end surfaces 14 and 15 in the width direction of the cushion sheet 13 toward the center in the width direction, and is narrower than the second sheet portion 43. A widthwise length W1 of the base end portion 47 is substantially equal to or less than a widthwise length W2 of the insertion hole 45.

The intermediate portion 49 has substantially the same width as the second sheet portion 43, for example. The intermediate portion 49 is wider than the base end portion 47. Here, the base end portion 47 corresponds to the narrow portion, and the intermediate portion 49 corresponds to the wide portion.

A widthwise length W3 in a tip surface 48a of the tip portion 48 is narrower than the widthwise length W2 of the insertion hole 45. Therefore, when the tip portion 48 of the insertion portion 46 is inserted into the insertion hole 45, the tip surface 48a of the tip portion 48 is easily inserted.

Next, a method of attaching the cushion sheet 13 to the electric wire 11 around which the band clip 12 is wrapped will be described.

As illustrated in FIG. 3, the clip portion 22 is inserted into the clip insertion hole 33 of the cushion sheet 13.

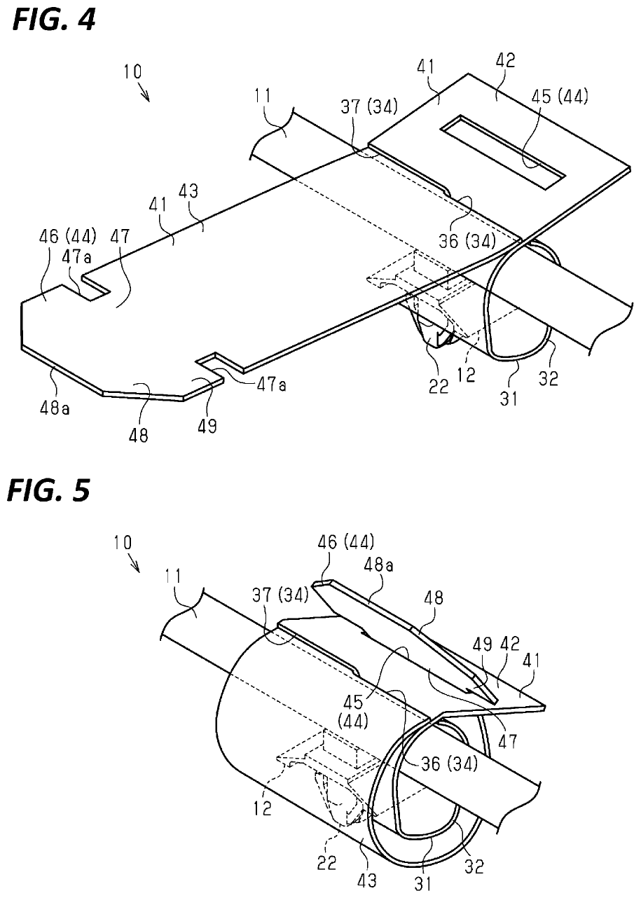

As illustrated in FIG. 4, the first sheet portion 32 of the first covering portion 31 is wrapped to cover the band portion 21 of the band clip 12. Subsequently, the slits 36 and 37 at the two ends of the first covering portion 31 are fitted to and engaged with each other. Thus, the band portion 21 can be covered. At this time, since the clip portion 22 is inserted into the clip insertion hole 33, it is exposed to the outside of the cushion sheet 13.

As illustrated in FIG. 5, the pair of second sheet portions 42 and 43 of the second covering portion 41 are wrapped to cover the first sheet portion 32 and the clip portion 22. Subsequently, the insertion portion 46 of the second sheet portion 43 is inserted into the insertion hole 45 of the second sheet portion 42. At this time, by inserting the insertion portion 46 into the insertion hole 45 up to the base end portion 47, which is the narrow portion, of the insertion portion 46, the intermediate portion 49, which is the wide portion, comes into contact with the periphery of the insertion hole 45 in the direction opposite to the insertion direction, and the insertion portion 46 is restricted from coming out of the insertion hole 45.

Operations of the present embodiment will be described below.

In the wire harness 10 of the present embodiment, each of the band clips 12 wrapped around the electric wire 11 is individually covered with a corresponding cushion sheet 13. Here, one of the two band clips 12 illustrated in FIG. 1 will be referred to as a band clip 12A, and the other of the two band clips 12 will be referred to as a band clip 12B. The band clip 12A and the band clip 12B are mounted to different vehicle panels. Specifically, as illustrated in FIG. 6, the band clip 12A is mounted in a mounting hole P1a of the vehicle panel P1. As illustrated in FIG. 7, the band clip 12B is mounted in a mounting hole P2a of the vehicle panel P2. The positions of the mounting hole P1a of the vehicle panel P1 and the mounting hole P2a of the vehicle panel P2 are different from each other.

As illustrated in FIG. 6, the band clip 12A is mounted in the mounting hole P1a of the vehicle panel P1. On the other hand, a mounting hole for mounting the band clip 12B does not exist in the vehicle panel P1. In such a case, the cushion sheet 13 attached to the band clip 12A is removed, and the cushion sheet 13 attached to the band clip 12B is left as it is. That is, only the band clip 12B is covered with the cushion sheet 13. In such a state, the clip portion 22 of the band clip 12A can be mounted in the mounting hole P1a of the vehicle panel P1. Then, since the band clip 12B that is not mounted is entirely covered with the cushion sheet 13, the generation of noise is suppressed.

As illustrated in FIG. 7, the band clip 12B is mounted in the mounting hole P2a of the vehicle panel P2. On the other hand, a mounting hole for mounting the band clip 12A does not exist in the vehicle panel P2. In such a case, the cushion sheet 13 attached to the band clip 12A is left as it is, and the cushion sheet 13 attached to the band clip 12B is removed. That is, only the band clip 12A is covered with the cushion sheet 13. In such a state, the clip portion 22 of the band clip 12B can be mounted in the mounting hole P2a of the vehicle panel P2. Then, since the band clip 12A that is not mounted is entirely covered with the cushion sheet 13, the generation of noise is suppressed.

Effects of the present embodiment will be described below.

(1) By inserting the insertion portion 46 of the cushion sheet 13 into the insertion hole 45, the end surface on the one end side in the length direction of the cushion sheet 13 is locked by the periphery of the insertion hole 45 in the insertion portion 46, and thus the band clip 12 can be covered without using an adhesive. Therefore, it is possible to prevent the band clip 12 from directly hitting the vehicle panels P1 and P2, and to suppress the generation of noise. Further, since the insertion hole 45 and the insertion portion 46 of the cushion sheet 13 are engaged with each other, adhesion, welding, and the like are not required. Since it is not fixed by adhesion or welding, even if the cushion sheet 13 is accidentally removed, it can be reattached.

(2) Due to the clip insertion hole 33 being provided as the positioning hole in the first covering portion 31 included in the main body of the cushion sheet 13, a part of the band clip 12 is inserted into the clip insertion hole 33, and thus relative misalignment between the band clip 12 and the cushion sheet 13 can be suppressed.

(3) Since the pair of slits 36 and 37 can be engaged with each other, adhesion, welding, and the like are not required.

(4) Since the first slit 36 and the second slit 37 extend in opposite directions in the width direction, when the cushion sheet 13 is wrapped around the band clip 12 so as to cover the band clip 12, the open end of the first slit 36 and the open end of the second slit 37 face each other, and thus the slits 36 and 37 are easily engaged with each other.

(5) The band portion 21 can be covered by the first covering portion 31, and the clip portion 22 and the first covering portion 31 can be covered by the second covering portion 41, and thus the entire band clip 12 can be covered. Thus, it is possible to prevent the band clip 12 from directly hitting the vehicle panels P1 and P2, and to suppress the generation of noise.

(6) Since the widthwise length W3 in the tip end surface 48a of the tip portion 48 of the insertion portion 46 is shorter than the widthwise length W2 of the insertion hole 45, the insertion portion 46 can be easily inserted into the insertion hole 45.

(7) Since the pair of slits 36 and 37 constituting the first engaging portion 34 are formed at substantially the same distance from the clip insertion hole 33, when the slits 36 and 37 are engaged with each other, the clip portion 22 is located on the side opposite to the engagement position in the circumferential direction of the electric wire 11. Therefore, the clip portion 22 can be prevented from being an obstacle when the slits 36 and 37 are engaged with each other.

### Other Embodiments

Note that the above embodiment can be modified and implemented as follows. The above embodiment and the following modifications can be implemented in combination with each other within a technically consistent range.
In the above embodiment, the first slit 36 and the second slit 37 are formed at substantially the same distance from the clip insertion hole 33, but the present invention is not limited to this. The distances from the clip insertion hole 33 to the slits 36 and 37 may be different. For example, the distance from the first slit 36 to the clip insertion hole 33 may be shorter than the distance from the second slit 37 to the clip insertion hole 33. Also, the distance from the first slit 36 to the clip insertion hole 33 may be longer than the distance from the second slit 37 to the clip insertion hole 33.
In the above embodiment, a configuration having the pair of slits 36 and 37 is employed, but the present invention is not limited to this. For example, a configuration in which a plurality of slit pairs are provided or a configuration in which the slits 36 and 37 are omitted may be employed.
In the above embodiment, the widthwise length W3 of the tip portion 48 (tip surface 48a) is shorter than the widthwise length W2 of the insertion hole 45, but the present invention is not limited to this. For example, the widthwise length W3 of the tip portion 48 may be equal to or greater than the widthwise length W2 of the insertion hole 45.
In the above embodiment, the tip portion 48 has a tapered shape, but the tip portion 48 may have a constant-width shape. If the tip portion 48 has a constant-width shape, the widthwise length of the tip portion 48 is preferably equal to or less than the widthwise length of the intermediate portion 49, which is the wide portion. Further, when the tip portion 48 has a constant-width shape, the widthwise length of the tip portion 48 is preferably equal to or less than the widthwise length of the insertion hole 45.
In the above embodiment, a configuration having two covering portions 31 and 41 is employed, but there may be only one of the covering portions, or a configuration in which a covering portion is added and the number of covering portions is three or more may be employed.
In the above embodiment, a configuration having the clip insertion hole 33 is employed, but a configuration in which the clip insertion hole 33 is omitted may be employed. Further, positioning relative to the harness component is not limited to being performed using the through-hole, and may be performed using a slit or the like.
Although not particularly mentioned in the above embodiment, when the plurality of band clips 12 are attached to the electric wire 11, the orientation of the clip portion 22 can be any orientation for each band clip 12. That is, the orientations of the clip portions 22 may be the same for each band clip 12, or may be different.
In the above embodiment, a configuration in which the band clip 12 is used as the harness component is employed, but the present invention is not limited to this, and other harness components such as a connector may be employed.

The panels P1 and P2 of the embodiment may be referred to as harness mounts to which the wire harness 10 is fixed. The mounting holes P1a and P2a of the embodiment may be referred to as harness mount positions. The band clip 12 of the embodiment may be referred to as a wiring clamp. The cushion sheet 13 of the embodiment may be referred to as a cushion belt. The insertion portion 46 (base end portion 47, tip portion 48, intermediate portion 49, slits 47a, tip surface 48a) of the cushion sheet 13 of the embodiment may be referred to as a belt tip portion of the cushion belt. The tip surface 48a of the cushion sheet 13 of the embodiment may be referred to as a free end of the cushion belt. The second engaging portion 44 and the insertion hole 45 of the embodiment may be referred to as a buckle of a cushion belt, and the insertion hole 45 may be referred to as a buckle hole. The band portion 21 of the band clip 12 of the embodiment may be referred to as a tie band.

The present disclosure includes the following implementation examples.

Reference numerals of some of the components of the embodiments have been given, not for limitation, but as an aid to understanding. Some of the items described in the following implementation examples may be omitted, or some of the items described in the implementation examples may be selected or extracted to be combined.

[Supplementary note 1] Some implementation examples of the present disclosure are directed to a wire harness (10) used with a harness mount (P1; P2) having one or more harness mount positions (P1a; P2a), and the wire harness (10) includes:

an electric wire (11);

a plurality of wiring clamps (12) that are attached to a plurality of predetermined length positions on the electric wire (11) and are configured to fix the electric wire (11) to the harness mount (P1; P2); and

a plurality of cushion belts (13) respectively wrapped around the plurality of wiring clamps (12) at the plurality of predetermined length positions on the electric wire (11) in order to prevent the plurality of wiring clamps (12) from directly coming into contact with the harness mount (P1; P2),

wherein each of the cushion belts (13) may be configured to be positioned relative to a corresponding wiring clamp (12) and a corresponding length position on the electric wire (11) by only frictional engagement without using any of a gluing means, an adhesive means, and a joining means.

[Supplementary note 2] In some implementation examples of the present disclosure, each cushion belt (13) may be configured to be positioned relative to the corresponding wiring clamp (12) and the corresponding length position of the electric wire (11) by frictional engagement between a plurality of different portions of the cushion belt (13) and/or by frictional engagement between a plurality of different portions of the cushion belt (13) and the corresponding wiring clamp (12) and the corresponding length position of the electric wire (11).

[Supplementary note 3] In some implementation examples of the present disclosure, each cushion belt (13) may be configured to be removable from the corresponding wiring clamp (12) at the corresponding length position of the electric wire (11) by disengaging the frictional engagement between the plurality of different portions of the cushion belt (13) and/or by disengaging the frictional engagement between a plurality of different portions of the cushion belt (13) and the corresponding wiring clamp (12) and the corresponding length position of the electric wire (11).

[Supplementary note 4] In some implementation examples of the present disclosure, each of the plurality of cushion belts (13) may be a single belt made of a foam material integrally including: a belt tip portion (46) including a free end (48a); a buckle (44, 45) provided at a belt base end portion opposite to the belt tip portion; and a belt main body (31, 41) extending between the belt tip portion (46) and the belt base end portion.

[Supplementary note 5] In some implementation examples of the present disclosure, each cushion belt (13) may be maintained in a wrapped shape by only frictional engagement between the foam material of the belt tip portion (46) and the foam material of the buckle (44 and 45).

[Supplementary note 6] In some implementation examples of the present disclosure, the belt tip portion (46) may include a narrow portion (47) that is narrower than the belt main body (31 and 41) between the free end (48a) and the belt main body (31 and 41),

the buckle (44 and 45) may include a buckle hole (45) that allows the belt tip portion (46) to be inserted therein, and

the narrow portion (47) may frictionally engage with the buckle (44 and 45) in the buckle hole (45) to prevent the belt tip portion (46) from coming out of the buckle hole (45).

[Supplementary note 7] In some implementation examples of the present disclosure, the belt main body (31 and 41) of each cushion belt (13) has a pair of engaging slits (36 and 37) formed with a predetermined separation distance in the length direction of the cushion belt (13), and when the cushion belt (13) is wrapped once so as to cover the corresponding wiring clamp (12) among the plurality of wiring clamps (12) at the corresponding length position among the plurality of predetermined length positions of the electric wire (11), the frictional engagement of the pair of engaging slits (36 and 37) can prevent the cushion belt (13) from loosening.

[Supplementary note 8] In some implementation examples of the present disclosure, each cushion belt (13) may be configured such that the narrow portion (47) frictionally engages with the buckle (44 and 45) in the buckle hole (45) when the cushion belt (13) is wrapped twice so as to cover the corresponding wiring clamp (12) among the plurality of wiring clamps (12) at the corresponding length position among the plurality of predetermined length positions of the electric wire (11).

[Supplementary note 9] In some implementation examples of the present disclosure, the wiring clamp (12) may be a band clip (12) that includes:

a synthetic resin tie band (21) wrapped around the electric wire (11);

a synthetic resin lock portion (23) provided at the base end portion opposite to the tip portion of the tie band (21) so as to fix an extra length portion of the tip portion of the tie band (21) wrapped around the electric wire (11); and a synthetic resin clip (22) that protrudes from the lock portion (23) and engages with the harness mount (P1, P2) so as to fix the wiring clamp (12) to the harness mount (P1, P2).

[Supplementary note 10] In some implementation examples of the present disclosure, each cushion belt (13) may have a clip insertion hole (33) that allows passage of the clip (22) of the band clip (12) and does not allow passage of the lock portion (23).

[Supplementary note 11] In some implementation examples of the present disclosure, each cushion belt (13) may be a single punched product made of synthetic foamed resin or a single molded article made of synthetic foamed resin.

### LIST OF REFERENCE NUMERALS

10 Wire harness
11 Electric wire
12, 12A, 12B Band clip (Harness component)
13 Cushion sheet
14, 15 End surface
21 Band portion
22 Clip portion
23 Lock portion
24 Insertion port
31 First covering portion
32 First sheet portion
33 Clip insertion hole
34 First engaging portion
36 First slit
37 Second slit
41 Second covering portion
42, 43 Second sheet portion
44 Second engaging portion
45 Insertion hole
46 Insertion portion
47 Base end portion (Narrow portion)
47a Slit
48 Tip portion
48a Tip surface
49 Intermediate portion (Wide portion)
P1, P2 Vehicle panel (External component)
P1a, P2a Mounting hole
W1, W2, W3 Widthwise length

1. A cushion sheet that is softer than a harness component and covers the harness component, the cushion sheet comprising:
an insertion hole provided on one end side in a length direction of the cushion sheet; and
an insertion portion provided on an other end side in the length direction,
wherein the insertion portion includes a narrow portion corresponding to a width of the insertion hole, and a wide portion that is located closer to the other end side in the length direction than the narrow portion is and that wider than the narrow portion.

2. The cushion sheet according to claim 1, further comprising
a main body between the insertion hole and the insertion portion,
wherein the main body has a positioning hole for positioning relative to the harness component.

3. The cushion sheet according to claim 2, wherein the main body has a pair of slits at positions on opposite sides of the positioning hole, the slits being configured to engage with each other and cover a part of the harness component in a region between the slits.

4. The cushion sheet according to claim 3,
wherein the pair of slits includes:
a first slit extending from a first end surface in a width direction of the cushion sheet toward a second end surface in the width direction; and
a second slit extending from the second end surface in the width direction toward the first end surface in the width direction.

5. The cushion sheet according to claim 4,
wherein the harness component is a band clip configured to be attached to an electric wire, and
the main body includes:
a first covering portion that is provided between the first slit and the second slit and is configured to cover a band portion of the band clip; and
a second covering portion configured to cover a clip portion of the band clip and the first covering portion.

6. The cushion sheet according to claim 1, wherein in the insertion portion, a tip portion located closer to the other end side in the length direction than the wide portion is has a widthwise length that is shorter than a widthwise length of the insertion hole.

7. A wire harness comprising:
an electric wire;
a plurality of harness components that are attached to the electric wire and are configured to mount the electric wire to an external component; and
a plurality of cushion sheets that are softer than the harness components and individually cover the harness components,
wherein each of the cushion sheets includes an insertion hole provided on one end side in a length direction of the cushion sheet and an insertion portion provided on an other end side in the length direction, and
the insertion portion includes a narrow portion corresponding to a width of the insertion hole, and a wide portion that is located closer to the other end side in the length direction than the narrow portion is and that is wider than the narrow portion.

8. A wire harness comprising:
an electric wire;
a plurality of harness components that are attached to the electric wire and are configured to mount the electric wire to an external component; and
a plurality of cushion sheets that are softer than the harness components and individually cover all the harness components,
wherein the cushion sheet includes an insertion hole provided on one end side in a length direction of the cushion sheet and an insertion portion provided on an other end side in the length direction, and
the insertion portion includes a narrow portion corresponding to a width of the insertion hole, and a wide portion that is located closer to the other end side in the length direction than the narrow portion is and that is wider than the narrow portion.

9. The wire harness according to claim 7, wherein the harness component is a band clip configured to be attached to the electric wire.

10. The wire harness according to claim 8, wherein the harness component is a band clip configured to be attached to the electric wire.
